(19) United States
(12) Patent Application Publication
(10) Pub. No.: US 2011/0244727 A1
(43) Pub. Date: Oct. 6, 2011

(54) ELECTRICAL CONNECTOR AND ELECTRICAL CONNECTOR ASSEMBLY

(75) Inventors: KUO-CHI LEE, TAIPEI COUNTY (TW); CHIN-HUANG LIN, TAIPEI COUNTY (TW)

(73) Assignee: CONCRAFT HOLDING CO., LTD., GRAND CAYMAN (KY)

(21) Appl. No.: 13/158,762

(22) Filed: Jun. 13, 2011

Related U.S. Application Data
(62) Division of application No. 12/731,620, filed on Mar. 25, 2010.

(30) Foreign Application Priority Data
Dec. 11, 2009 (TW) 098223293

(51) Int. Cl. H01R 24/00

(52) U.S. Cl. 439/626

(57) ABSTRACT

An electrical connector assembly includes a first connector consisting of a terminal holding member having a plurality of terminals, each of the terminals having a distributing section; a second connector; and an adapter module. The adapter module includes an assembler member for coupling the first and second connectors together, and a terminal distributing member for coupling to the terminal holding member, and formed with a first row of retention holes and a second row of retention holes spaced apart respectively from the first retention holes in parallel manner. Once the terminal holding member is coupled to the terminal distributing member, the terminals extend respectively through the first and second holes in the terminal distributing member, thereby forming and exposing two parallel rows of the distributing sections of the terminals from a flat end of the terminal distributing member.

### CROSS-REFERENCE TO RELATED APPLICATION

This application is a divisional application of the U.S. patent application Ser. No. 12/731,620 filed on Mar. 25, 2010, the subject matter of which is incorporated herein by reference.

### BACKGROUND OF THE INVENTION

1. Field of the Invention

The present invention relates to an electrical connector assembly, more particularly to an electrical connector assembly having a plurality of rows of terminals.

2. Description of the Prior Art

Since the transmission speed of the electrical connectors becomes faster as days gone by, the terminals of an electrical connector for insertion into the mother board must be spaced apart or staggered to one another at predetermined gap so as to prevent electromagnetic interference among the terminals. The manufacturers must produce new electrical connector having terminals with different specifications to conform to the soldering points on the new mother board, thereby adversely incurring undesired expense. It is urgently needed to solve the above-stated problem.

FIG. 1 shows a partly exploded view of a conventional electrical connector. The electrical connector 1000 includes an insulated body 110 and first, second and third rows of terminals 120, 130, and 140. In order for the terminals to be staggered relative to one another, the conventional electrical connector is provided with at least two rows of terminals 120, 130 of two different specifications, as best shown in FIG. 1, thereby resulting in extra expense for opening new mold.

In addition, the terminals 120, 130, 140 respectively have bifurcated structures, which are used for fixing on the insulated body 110. Thus, the terminals 120, 130, 140 are fabricated by punching out several long, flat metal plates so as to obtain the bifurcated structures. A large waste of metal pieces is remained after the punching operation, and causes environmental pollution.

Several electrical connectors of different dimensions and specifications are invented ceaselessly. Some newly produced electronic apparatuses require the most advanced electrical connector for market competition. At the same time, the conventional electrical connectors still in use must satisfy the general users of the electronic apparatuses.

For instance, it usually requires more than five electrical connectors for connecting the peripheral devices to the display screen and the mother board of a computer set. Four to five USB (Universal Serial Bus) devices and HDMI (High Definition Multimedia Interface), the most common ones, may be implemented in a computer set so that the electrical connectors of different types are generally stacked one above the other when in use.

In addition, since new mother boards are developed quickly day by day, the electrical connectors for application with the new mother boards differed from one another. Therefore, an electrical connector assembly of a specific type cannot get along with the newly produced mother board. As a result, the manufacturers must design a new mold for developing a new electrical connector, thereby increasing the undesired production cost.

Referring to FIGS. 1A and 1B, wherein FIG. 1A shows a perspective view of a conventional electrical connector assembly 1000a while FIG. 1B is an exploded view of the conventional electrical connector assembly 1000a shown in FIG. 1A. The conventional electrical connector assembly 1000a includes a first connector 110a, a second connector 120a, an assembler member 130a and a fixing member 140a.

The assembler member 130a couples the first and second connectors 110a, 120a together. The first connector 110a has a first row of terminals 111a. The first terminals 111a have soldering sections 1111a arranged in two array manner and spaced from one another at a preset distance by the fixing member 140a such that the first terminals 111a extend through the assembler member 130a and the fixing member 140a. The second connector 120a has a second row of terminals 121a. The second terminals 121a have soldering sections 1211a arranged in two array manner and spaced from one another at a preset distance by the fixing member 140a.

Note that in the aforesaid conventional electrical connector assembly 1000a, the first and second connectors are coupled by the assembler member 130a together one stacking over the other. However each connector requires terminals of a specific type so that several specific types of terminals are needed in order to maintain the soldering sections 1111a, 1211a in two array manner over two tongue plates 112a, 122a thereof, thereby causing inconvenience during the assembly operation of the conventional electrical connector assembly. Moreover, since the soldering sections in the terminals are required to design to complement with the different position of soldering spots on the mother board, an extra manufacture cost is resulted. In addition, fabrication of the terminals in the first and second connectors can be conducted only after determining relative to the soldering spots on the mother board, there may occur late delivery of the electrical connector assemblies and suffer loss of market competition.

### SUMMARY OF THE INVENTION

Therefore, the object of the present invention is to provide an electrical connector having rows of terminals. The electrical connector includes a terminal holding member, a terminal distributing member and a plurality of terminals, wherein the terminals have distributing sections spaced apart from one another in parallel manner and extending along a horizontal axis. After the terminal holding and distributing members are coupled together, the distributing sections of the terminals form in parallel rows. For the terminals belonging to a specific type, a single insert operation is required in order to mount the terminals on the electrical connector.

The electrical connector according to the present invention includes a terminal holding member having a plurality of terminals and a terminal distributing member. The terminals are formed by punching the flat long metal plates into elongated stick and bending the same. Each terminal has a distributing section. The terminal distributing member is formed first and second rows of retention holes in parallel manner. When the terminal holding member is coupled to the terminal distributing member, the distributing sections are exposed from the distributing member in two parallel rows.

Each of the first retention holes has a first insert hole section extending parallel to a main axis, a first distributing hole section extending parallel to a first axis. Each of the second retention holes has a second insert hole section extending parallel to the main axis, a second distributing hole section extending parallel to a second axis.

When the terminal holding member is coupled to the terminal distributing member, the first terminals extend respectively through the first and second insert hole sections and the first and second distributing hole sections in the terminal distributing member, thereby forming and exposing two parallel rows of the distal ends of the first terminals from a flat end of the terminal distributing member.

In another aspect of the invention, the electrical connector assembly includes a first connector, a second connector and an adapter module. The first connector has a plurality of terminals, each having a distributing section. The adapter module includes a terminal holding member and a terminal distributing member. The holding member is used for holding the first and second connectors together. The terminal distributing member is coupled to the holding member, and is formed with a first row of retention holes and a second row of retention holes parallel to the first holes.

Once the terminal holding member is coupled to the terminal distributing member, the first terminals extend respectively through the first and second insert hole sections and the first and second distributing hole sections in the terminal distributing member, thereby forming and exposing two parallel rows of the distributing sections of the first terminals from two side of a flat end of the terminal distributing member.

As described above, only a single insert operation is required during the assembling process in order to insert the terminals of one specification, where the distributing sections of the terminals automatically bent and are retained securely in the terminal distributing member in parallel rows, thereby economizing the assembling and fabrication time. In other words, metal waste is minimized since the terminals are formed by bending the flat, long metal plate due to lesser presence of bifurcated structure in the terminals.

By simple variation in the adapter module, pieces of independently located connectors can be coupled electrically to the adapter module so as to result in different electrical connector assembly. Note that first and second connectors can be independently operated and do not require any alteration due to possessing the same terminal structure but are designed in different ways. By just simply arranging the rows of retention holes in the distributing member, the distributing sections of the terminals are arranged to be compatible with the soldering spots in the different mother boards. Thus, the manufacturers only need to produce the connectors of different specifications. After assuring the specification of the mother board, the distributing sections of the terminals in the connector are arranged in such a manner to complement with the soldering spots of the desired mother board.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a partly exploded view of a prior art electrical connector;

FIG. 1A shows a perspective view of a conventional electrical connector assembly;

FIG. 1B is an exploded view of the conventional electrical connector assembly shown in FIG. 1A;

FIG. 2 is a perspective view of the first embodiment of an electrical connector of the present invention;

FIG. 3 is an exploded view of the first embodiment shown in FIG. 2;

FIG. 4 is a lateral side view of a terminal distributing member employed in the first embodiment of the electrical connector of the present invention;

FIG. 5 is a fragmentary sectional view of the terminal distributing member employed in the first embodiment, illustrating prior to insertion of a terminal into the terminal distributing member;

FIG. 5A is a fragmentary sectional view of the terminal distributing member employed in the first embodiment, illustrating after inserting the terminal into the terminal distributing member;

FIG. 6 is a perspective view of the second embodiment of the electrical connector of the present invention;

FIG. 7 is an exploded view of the second embodiment of the electrical connector of the present invention;

FIG. 8 is a top planar view of the terminal distributing member employed the second embodiment shown in FIG. 6;

FIG. 9 is a fragmentary sectional view of the terminal distributing member employed in the second embodiment, illustrating prior to insertion of a terminal into the terminal distributing member;

FIG. 9A is a fragmentary sectional view of the terminal distributing member employed in the second embodiment, illustrating after inserting the terminal into the terminal distributing member;

FIG. 10 is a top planar view of the terminal distributing member employed the third embodiment of the electrical connector of the present invention;

FIG. 11 is a fragmentary sectional view of the terminal distributing member employed the third embodiment of the electrical connector of the present invention;

FIG. 12 is a perspective view of an electrical connector assembly of the present invention;

FIG. 13 is an exploded view of the electrical connector assembly of the present invention;

FIG. 14 is a top planar view of the terminal distributing member employed in shown in FIG. 13;

FIGS. 15 and 16 are fragmentary sectional views of the terminal distributing member employed in the electrical connector of the present invention;

FIG. 17 is an exploded view of another embodiment of the electrical connector assembly of the present invention;

FIG. 18 is a top planar view of the terminal distributing member employed in the another embodiment of the electrical connector assembly of the present invention;

FIGS. 19 are 20 are fragmentary sectional views of the terminal distributing member employed in the another embodiment of the electrical connector assembly of the present invention;

FIG. 21 is an exploded view of yet another embodiment of the electrical connector assembly of the present invention;

FIG. 22 is a top planar view of the terminal distributing member employed in the yet another embodiment of the electrical connector assembly of the present invention; and

FIGS. 23 and 24 are fragmentary sectional views of the terminal distributing member employed in the yet another embodiment of the electrical connector assembly of the present invention.

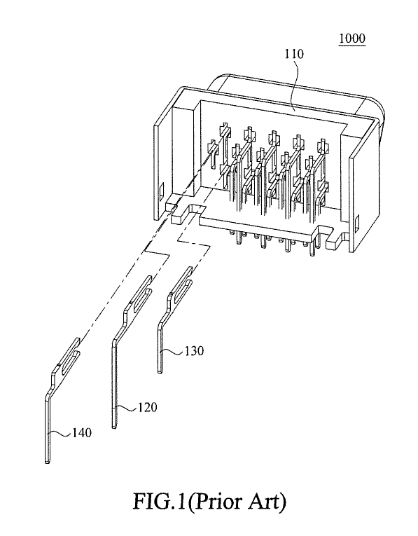

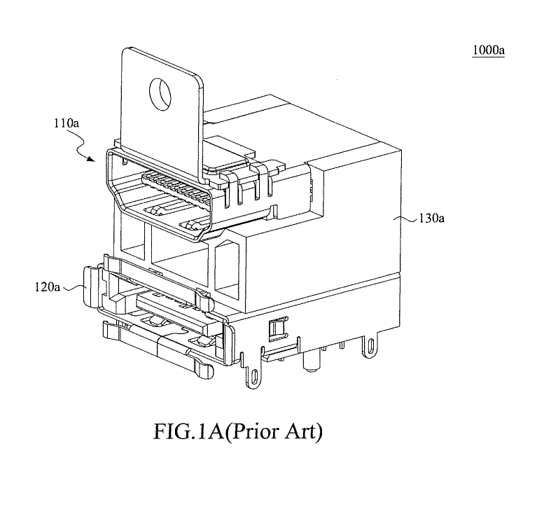

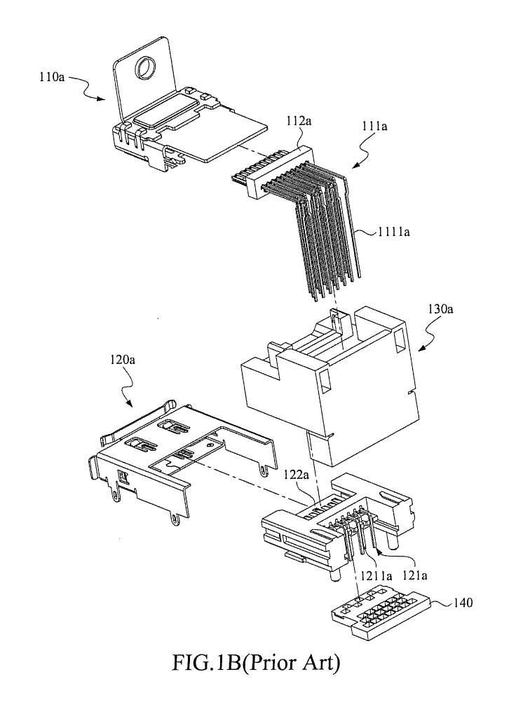

### DETAILED DESCRIPTION OF THE PREFERRED EMBODIMENTS

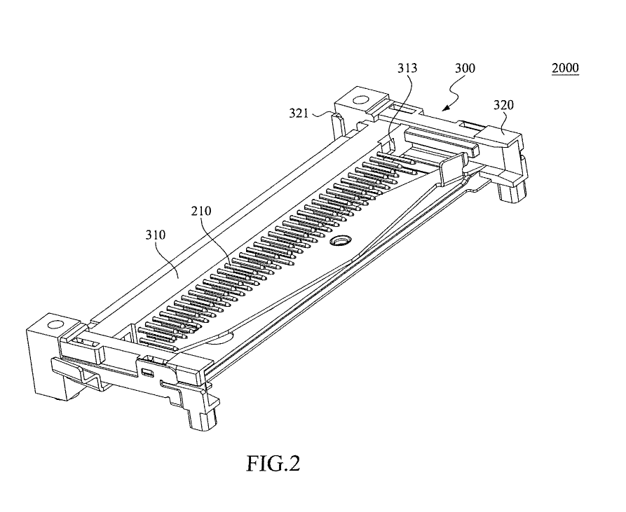

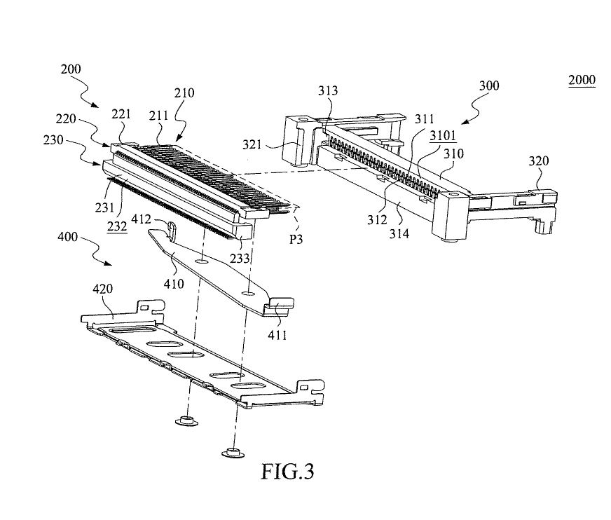

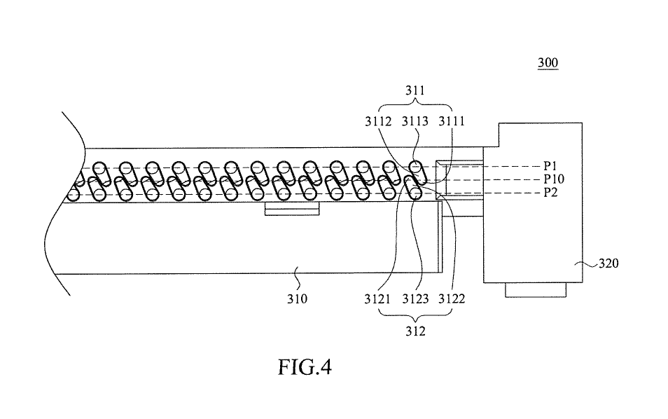

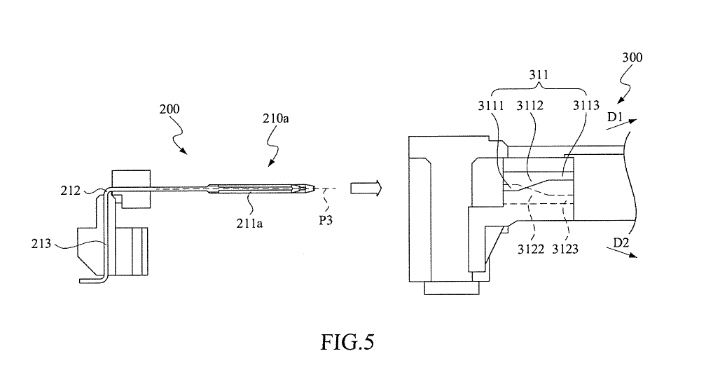

Referring to FIGS. 2 to 5, wherein FIG. 2 is a perspective view of the first embodiment of an electrical connector of the present invention; FIG. 3 is an exploded view of the first embodiment shown in FIG. 2; FIG. 3 is an exploded view of the first embodiment shown in FIG. 2 while FIG. 4 is a lateral side view of a terminal distributing member employed in the first embodiment of the electrical connector of the present invention. FIG. 5 is a fragmentary sectional view of the terminal distributing member employed in the first embodiment, illustrating prior to insertion of a terminal into the terminal distributing member.

As illustrated, the electrical connector 2000 of the present invention includes a terminal holding member 200 and a terminal distributing member 300.

The terminal holding member 200 has a plurality of terminals 210 and a fixing unit. The fixing unit preferably includes a first fixing element 220 and a second fixing element 230. FIG. 5 shows the structure of one terminal 210a prior to coupling the terminal holding member 200 with the terminal distributing member 300. FIG. 3 illustrates a condition, where the terminals 210 are installed on the terminal holding member 200.

As shown in FIG. 5, each terminal 210a has a distributing section 211a, a connecting section 213 and an inclined section 212 interconnecting the distributing and connecting sections 211a, 213. Once the terminals 210a are installed on the terminal holding member 200 (i.e., before the terminal holding member 200 is coupled with the terminal distributing member 300), the distributing sections 211a, the connecting sections 213 and the inclined sections 212 of the terminals 210a are disposed in parallel manner along a horizontal line P3 and spaced apart from one another a preset distance.

As shown in FIG. 3, partial portions of the distributing sections 211 in the terminals 210 are mounted on the first fixing element 220 via the insert molding process. The first fixing element 220 has a pair of first engaging elements 221 at two lateral sides thereof.

Partial portions of the connecting sections 211 in the terminals 210 are mounted on the second fixing element 230 via the insert molding process. The second fixing element 230 includes a fixing body 231 and a pair of second engaging elements 233 at two lateral sides thereof.

The terminal distributing member 300 is coupled to the terminal holding member 200, and includes a distributing body 310 having left and right clamping arms 320 extending laterally from a front side thereof. The rear side 3101 of the distributing body 310 is formed with a first row of retention holes 311 and a second row of retention holes 312 spaced apart respectively from the first retention holes 311 in parallel manner. The rear side 3101 of the distributing body 310 is further formed with left and right engaging recesses 313 and a positioning block 314 such that once the terminal holding member 200 and the terminal distributing member 300 are coupled tightly together, the first engaging elements 221 of the first fixing element 220 extend respectively into the left and right engaging recesses 313 in the distributing body 310 while the second engaging elements 233 of the fixing element 230 engage the positioning block 314 of distributing body 310.

A memory card (not shown) can be held between the left and right clamping arms 320 of the distributing body 310. The left and right clamping arms 320 of the distributing body 310 are provided with a pair of downward projecting third engaging elements 321 that fastened securely to the rear side 232 of fixing body 231, thereby enhancing tight coupling effect between the terminal holding member 200 and the terminal distributing member 300.

The electrical connector 2000 of the present invention further includes a card ejection mechanism 400 having a card base 420 mounted on the terminal distributing member 300, and an ejection plate 410 mounted pivotally to the card base 420. The ejection plate 410 is provided with pull and push tabs 411, 412 in such a manner that pivotal movement of the ejection plate 410 relative to the card base 420 via the tabs 411, 412 results in removal of the memory card from the left and right clamping arms 320 of the distributing body 310.

Referring to FIGS. 4 and 5, each of the first retention holes 311 has a first insert hole section 3111 extending along to a main axis P10, a first distributing hole 3113 section extending along a first axis P1 and a first inclined hole section 3112 interconnecting spatially the first insert and distributing hole sections 3111, 3113 and extending along a first inclined direction D1.

Each of the second retention holes 312 has a second insert hole section 3121 extending along the main axis P10, a second distributing hole section 3123 extending along a second axis P2 and a second inclined hole section 3122 interconnecting spatially the second insert and distributing hole sections 3121, 3123 and extending along a second inclined direction D2. The second inclined direction D2 is parallel to the first inclined direction D1 while the main axis P10, the first axis P1 and the second axis P2 are parallel to one another.

As illustrated in FIG. 5, since the distributing sections 211a of the terminals 210a are disposed in parallel manner along the horizontal line P3, once the terminal holding member 200 is coupled to the terminal distributing member 300, the distributing sections 211a of the first terminals 210a extend respectively through the first and second insert hole sections 3111, 3121, the first and second inclined hole sections 3112, 3122, and the first and second distributing hole sections 3113, 3123 in the terminal distributing member 300, thereby forming and exposing a first row of the distributing sections 211 at one side the horizontal line P3 and a second row of the distributing sections 211 at the other side the horizontal line P3 as best shown in FIGS. 3 and 5.

Note that the terminals belong to one specification and the assembler needs to carry out a single insert process in order to install the terminals on the terminal holding and distributing members 200,300.

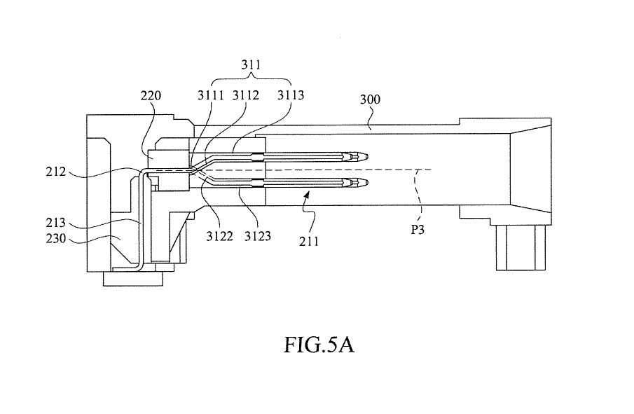

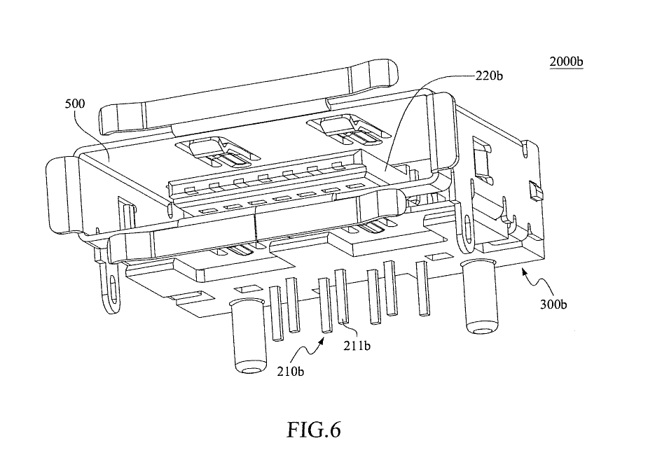

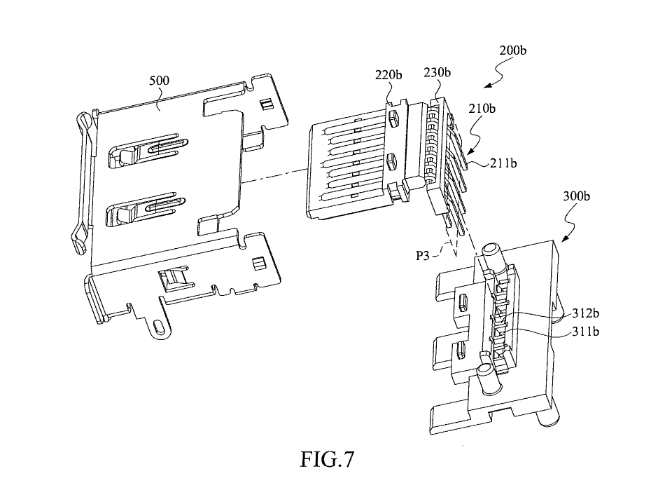

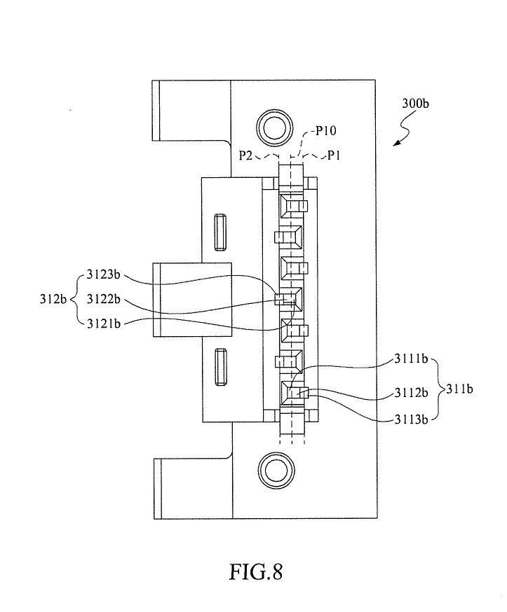

Referring to FIGS. 6 to 9, wherein FIG. 6 is a perspective view of the second embodiment of the electrical connector of the present invention; FIG. 7 is an exploded view of the second embodiment of the electrical connector of the present invention; and FIG. 8 is a top planar view of the terminal distributing member employed the second embodiment shown in FIG. 6.

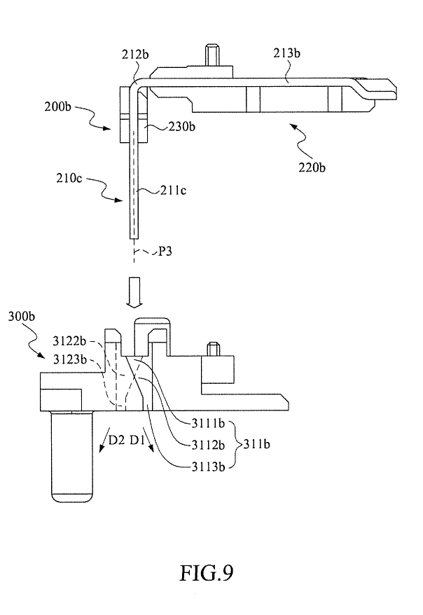

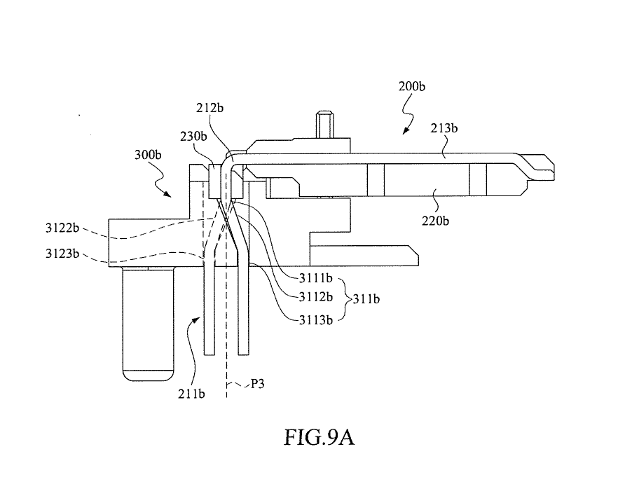

The second embodiment has the structure similar to the first embodiment, except in that the second embodiment further includes a metal casing 500 for enclosing the terminal holding member 200b and the terminal distributing member 300b from above, as best shown in FIG. 7. FIG. 9 is a fragmentary sectional view of the terminal distributing member 300b employed in the second embodiment, illustrating prior to insertion of the terminals 210c into the terminal distributing member 300b. In this embodiment, once the terminal holding member 200b is coupled to the terminal distributing member 300b, the distributing sections 211b of the terminals 210b are disposed in the state as shown in FIG. 3.

As shown in FIG. 9, each terminal 210c has a distributing section 211c, a connecting section 213b and an inclined section 212b interconnecting the distributing and connecting sections 211c, 213b. Prior to coupling the terminal holding member 200 onto the terminal distributing member 300, the distributing sections 211c, the connecting sections 213b and the inclined sections 212b of the terminals 210c are disposed in parallel manner and spaced apart from one another a preset distance.

As shown in FIGS. 8 and 9, each of the first retention holes 311b has a first insert hole section 3111b extending along a main axis P10, a first distributing hole section 3113b extending along a first axis P1 and a first inclined hole section 3112b interconnecting spatially the first insert and distributing hole sections 3111b, 3113b and extending along the first inclined direction D1.

Each of the second retention holes 312b has a second insert hole section 3121b extending along a main axis P10, a second distributing hole section 3123b extending along a second axis P1 and a second inclined hole section 3122b interconnecting spatially the second insert and distributing hole sections 3121b, 3123b and extending along the second inclined direction D2. The second inclined direction D2 is parallel to the first inclined direction D1 while the main axis P10, the first axis P1 and the second axis P2 are parallel to one another.

As shown in FIG. 9, the distributing sections 211c of the terminals 210c are disposed in parallel manner along the horizontal line P3. Thus, once the terminal holding member 200b is coupled to the terminal distributing member 300b, each of the first terminal 210c extends through the first and second insert hole sections 3111b, 3121b, the first and second inclined hole sections 3112b, 3122b, and the first and second distributing hole sections 3113b, 3123b in the terminal distributing member 300b, thereby forming and exposing the first row of the distributing sections 211c at one side the horizontal line P3 and the second row of the distributing sections 211c at the other side the horizontal line P3 as best shown in FIGS. 7 and 9A.

Thus, the terminals in the present electrical connector are spaced apart or staggered to one another at predetermined gap to prevent electromagnetic interference among the terminals, since the transmission speed of through the terminals becomes faster as days gone by.

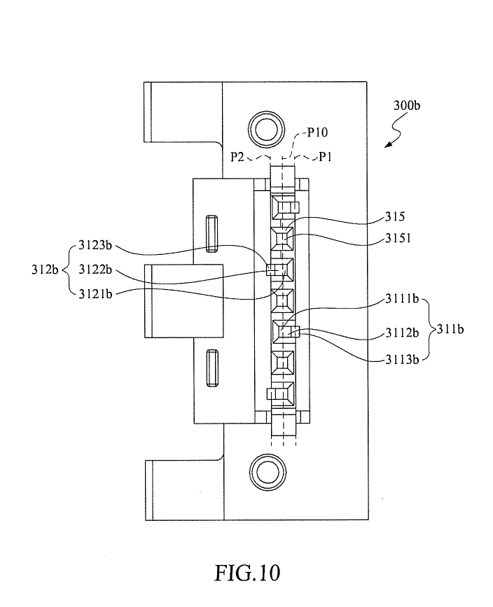

Referring to FIGS. 10 and 11, wherein FIG. 10 is a top planar view of the terminal distributing member employed the third embodiment of the electrical connector of the present invention and FIG. 11 is a fragmentary sectional view of the terminal distributing member employed the third embodiment of the electrical connector of the present invention.

The third embodiment is differed from the second embodiment in that the terminal distributing member 300b is further formed with a row of third retention holes 315 spaced apart from the first retention holes 311b and the second retention holes 312b in parallel manner.

Each of the third retention holes 315 has a third insert hole section 3151 extending along the main axis P10 such that when the terminal holding member 200b is coupled to the terminal distributing member 300b, the terminals 210c (see FIG. 9) extend respectively through the first, second and third insert hole sections (3111b, 3121b, 3151), the first and second distributing hole sections (3113b,3123b) and the third insert hole section 3151 in the terminal distributing member 300b, thereby forming the first row of the distributing sections 211b at one side of the horizontal line P3, the second row of the distributing sections 211b at the other side of the horizontal line P3 and a third row of the distributing sections 211b along the horizontal line P3.

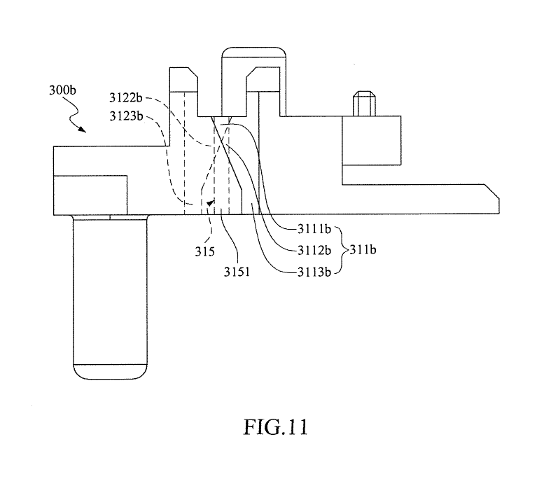

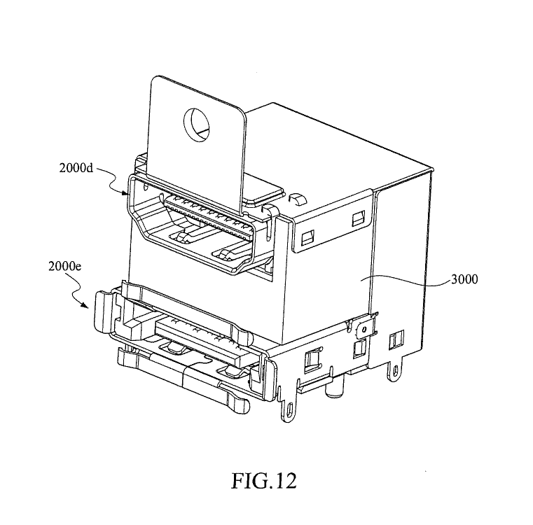

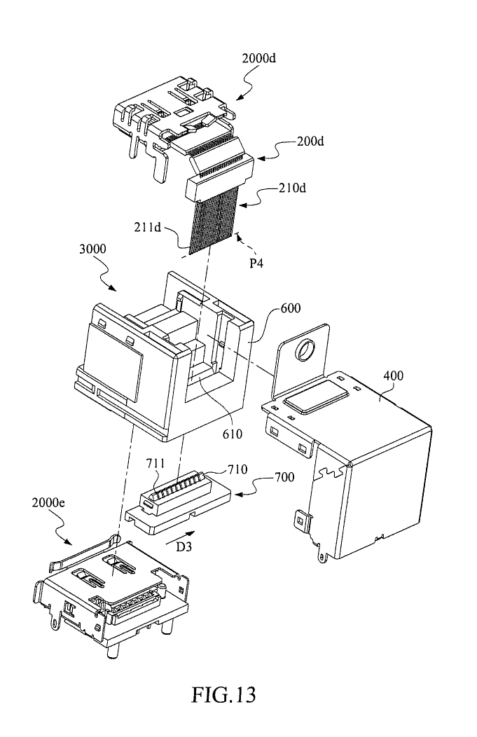

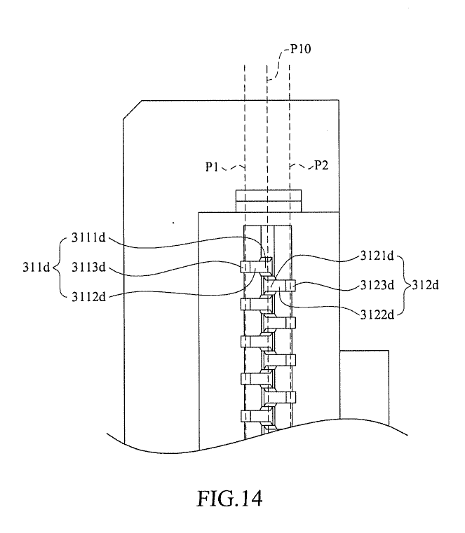

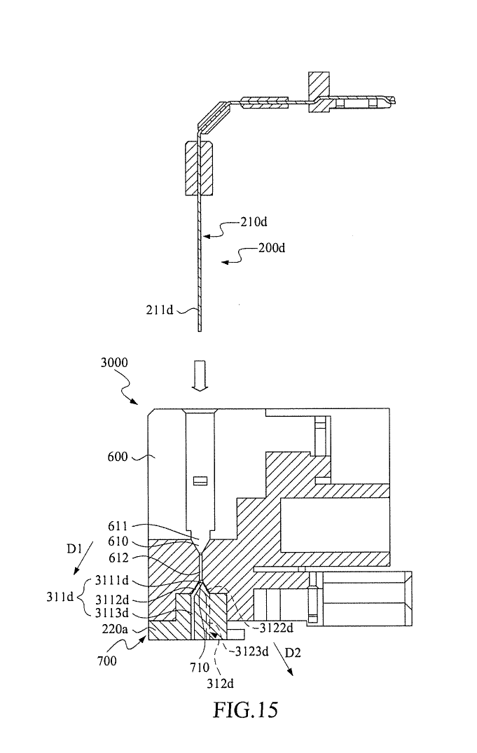

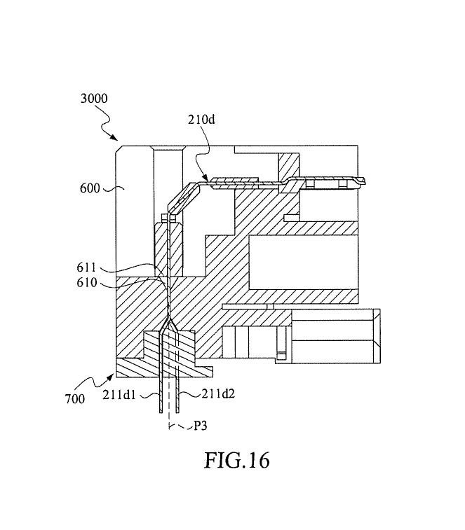

Referring to FIGS. 12 to 15, wherein FIG. 12 is a perspective view of an electrical connector assembly of the present invention; FIG. 13 is an exploded view of the electrical connector assembly of the present invention; FIG. 14 is a top planar view of the terminal distributing member shown in FIG. 13; FIGS. 15 and 16 are fragmentary sectional views of the terminal distributing member employed in the electrical connector assembly of the present invention. The electrical connector assembly includes a first connector 2000d, a second connector 2000e and an adapter module 3000, wherein the terminals 210d in the first connector 2000d have a length longer than those employed in the previous embodiments. The second connector 2000e has the same structure as the second and third embodiments. FIG. 13 shows a state prior to inserting into the terminal distributing member 700, the distributing sections 211d of the terminals 210d are disposed parallel to one another and extend along the third axis P4.

The adapter module 3000 includes a holding member 600 and the terminal distributing member 700. The holding member 600 is formed with a guiding hole 610 extending along an extending direction D3. As illustrated in FIG. 15, the guiding hole 610 is constituted by a first (upper) hole section 611 and a second (lower) hole section 612 narrower than the first one in width. Since the terminals 210d are aligned along the axis P4, the distributing sections of the terminal 210d can be inserted fittingly and easily through the guiding hole 610 in the assembler member via the first hole section 611 due to large width of the first hole section 611.

The terminal distributing member 700 includes a distribution block 710 projecting upwardly from the distributing body and is formed with two rows of inclined slots 711. When the holding member 600 is coupled to the distributing member 700, the adapter module 3000 is accordingly formed with first and second rows of retention holes 311d, 312d in parallel manner and in spatial communication with the guiding hole 610. Under this condition, when the first connector 2000d is coupled to the adapter module 3000, the distributing sections of the terminals 210d extend respectively into the first retention holes 311d, and the second retention holes 312d via the guiding hole 610, thereby forming the first and second rows of the distributing sections 211d1, 211d2 at both sides of the horizontal line P3, as best shown in FIG. 16.

Referring to FIGS. 14 and 15, each of the first retention holes 311d has a first insert hole section 3111d extending along the main axis P10, a first distributing hole 3113d section extending along the first axis P1 and through the distributing member 700, and the first inclined hole section 3112d interconnecting spatially the first insert and distributing hole sections 3111d, 3113d and extending along the first inclined direction D1. Note that the first inclined hole section 3112d is cooperatively defined by the respective inclined slot 711 and inner walls of the holding member 600.

Each of the second retention holes 312d has a second insert hole section 3121d extending along the main axis P10, the second distributing hole section 3123d extending along the second axis P2 and the second inclined hole section 3122d interconnecting spatially the second insert and distributing hole sections 3121d, 3123d and extending along the second inclined direction D2. The second inclined direction D2 is parallel to the first inclined direction D1 while the main axis P10, the first axis P1 and the second axis P2 are parallel to one another. Note that the second inclined hole section 3122d is cooperatively defined by the respective inclined slot 711 and inner walls of the holding member 600.

When the first connector 2000d is coupled to the adapter module 3000, the first terminals 210d extend respectively through the guiding hole 610, the first and second insert hole sections 3111d, 3121d, the first and second inclined hole sections 3112d, 3122d and through the first and second distributing hole sections 3113d, 3123d of the first and second retention holes 311d, 312d in the adapter module 3000.

Thus, once the first connector 2000d is coupled to the adapter module 3000, the distributing sections of the terminals 210d form the first and second rows of the distributing sections 211d1, 211d2 at both sides of the horizontal line P3, as best shown in FIG. 16.

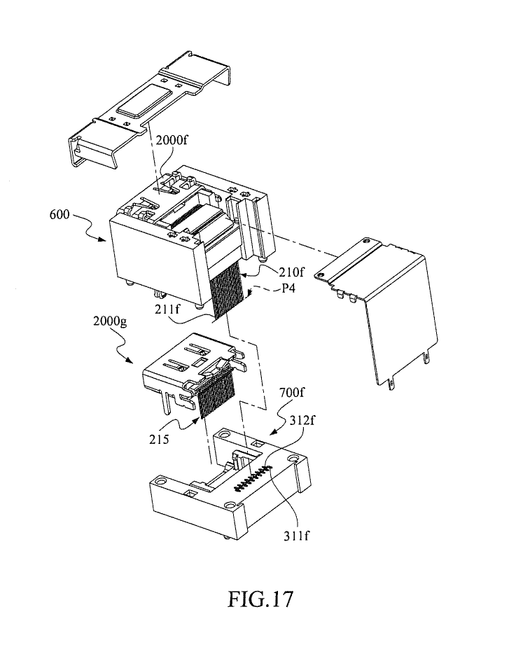

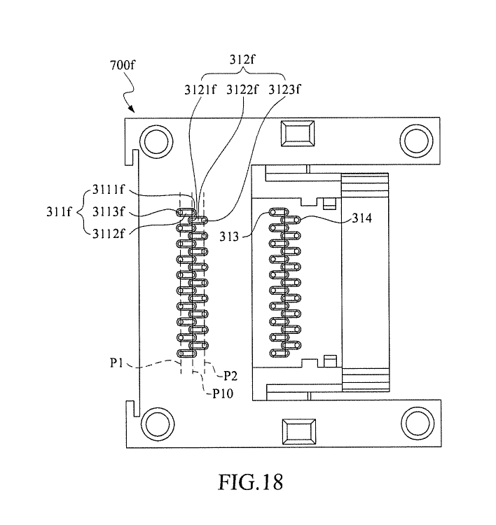

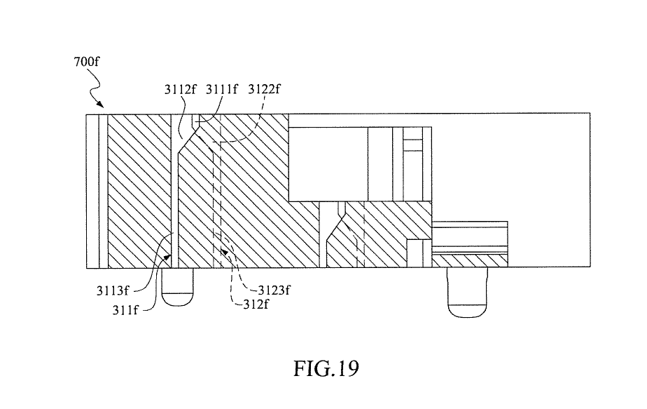

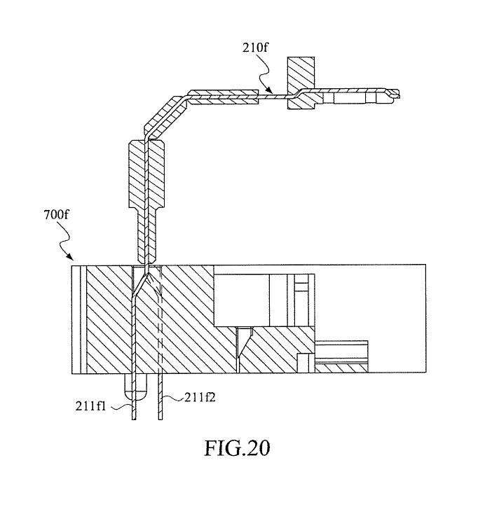

Referring to FIGS. 17 to 20, wherein FIG. 17 is an exploded view of another embodiment of the electrical connector assembly of the present invention; FIG. 18 is a top planar view of the terminal distributing member employed in the another embodiment of the electrical connector assembly of the present invention; while FIGS. 19 are 20 are fragmentary sectional views of the terminal distributing member employed in the another embodiment of the electrical connector assembly of the present invention. The embodiment is similar to the previous embodiment in structure, except in that the guiding hole 610 is excluded therefrom.

The first and second retention holes 311f, 312f are formed through the distributing member 700f. When the first connector 2000f is coupled to the distributing member 700f, the terminals 210f of the first connector 2000f extend respectively through the first and second insert hole sections 3111f, 3121f, the first and second inclined hole sections 3112f, 3122f and through the first and second distributing hole sections 3113f, 3123f of the first and second retention holes 311f, 312f in the distributing member 700f, thereby the first and second rows of the distributing sections 211f1, 211f2 at both sides of the horizontal line P3, as best shown in FIG. 20.

In addition, the distributing member 700f can be formed with the first and second rows of retention holes 316,317 in order to distribute the terminals 215 of the second connector 2000g. Note the first and second retention holes 316, 317 have the structure similar the first and second retention holes 311f, 312f such that detailed arrangement of the terminals 215 is omitted herein.

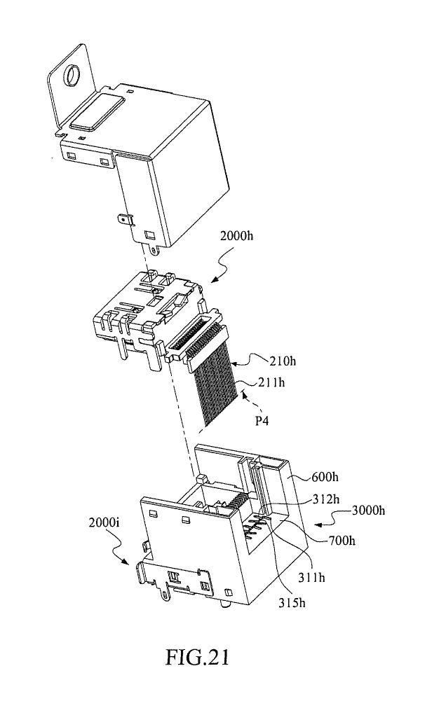

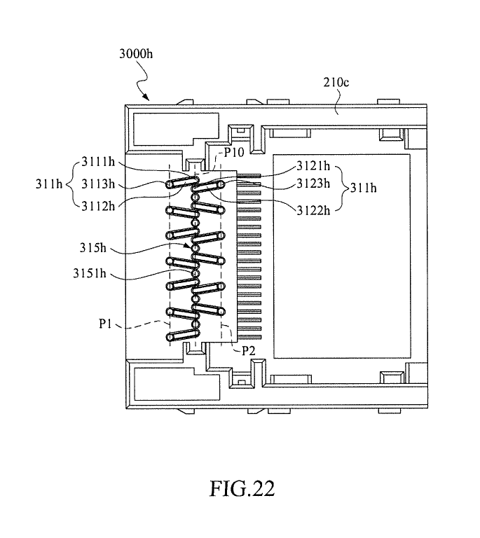

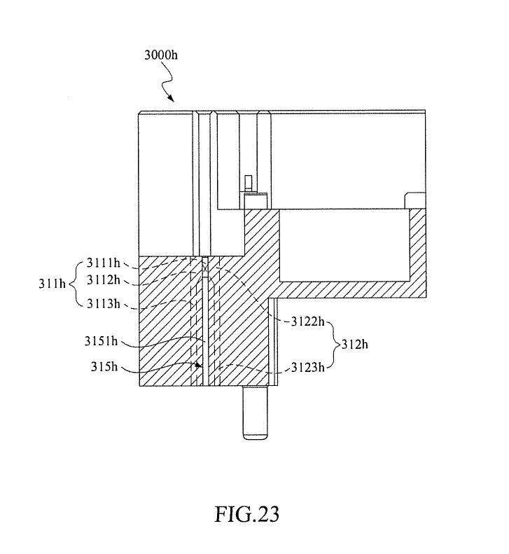

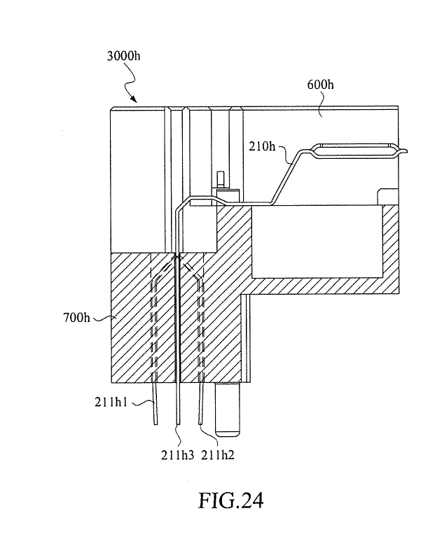

Referring to FIGS. 21 to 24, wherein FIG. 21 is an exploded view of yet another embodiment of the electrical connector assembly of the present invention; FIG. 22 is a top planar view of the terminal distributing member employed in the yet another embodiment of the electrical connector assembly of the present invention; and FIGS. 23 and 24 are fragmentary sectional views of the terminal distributing member employed in the yet another embodiment of the electrical connector assembly of the present invention. The yet another embodiment has the similar structures of the previous two embodiments, except in that the terminal holding and distributing members 600h, 700h are integrally formed with each other and cooperatively have the first, second and third rows of retention holes 311h, 312h and 315h in parallel manner

Each of the third retention holes 315 has a straight insert hole section 3151h extending along the main axis P10. Thus, after assembly of the terminal 210h on the adapter module 3000h, the distributing sections of the terminals 210h extend through the first, second and third insert hole sections (3111h,3121h 3151h), and the first, second and third distributing sections (3113h, 3123h,3151h), thereby forming the first row of the distributing sections 211h1 along the first axis P1, the second row of the distributing sections 211h2 along the second axis P2, and the third row of the distributing sections 211h2 along the horizontal line P3, wherein 211h1, 211h2, 211h3 are parallel to one another.

As described above, in each embodiment of the electrical connector assembly of the present invention, only a single insert operation of the terminals of one specification is required during the assembling process, where the distributing sections of the terminals are arranged in parallel rows, thereby economizing the assembling and fabrication time. In other words, metal waste is minimized since the terminals are formed by bending the flat, long metal plate due to lesser presence of bifurcated structure in the terminals.

By utilizing simple variation in the adapter module, two pieces of independently located first and second connectors can be coupled electrically to the adapter module so as to result in different electrical connector assembly. Note that the first and second connectors can be independently operated and do not require any alteration due to possessing the same terminal structure but are designed in different ways. By just simply arranging the rows of retention holes in the distributing member, the distributing sections of the terminals are arranged to be compatible with the soldering spots in the different mother boards. Thus, the manufacturers only need to produce the connectors of different specifications. After assuring the specification of the mother board, the distributing sections of the terminals in the connector are arranged in such a manner to complement with the soldering spots of the desired mother board.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electrical connector assembly comprising:
a first connector including
a terminal holding member having a plurality of first terminals, each of said first terminals having a distributing section;
a second connector; and
an adapter module including
an assembler member for coupling said first and second connectors together, and
a terminal distributing member for coupling to said terminal holding member, and formed with a first row of retention holes and a second row of retention holes spaced apart respectively from said first retention holes in parallel manner;
wherein, once said terminal holding member is coupled to said terminal distributing member, said first terminals extend respectively through said first and second holes in said terminal distributing member, thereby forming and exposing two parallel rows of said distributing sections of said first terminals from a flat end of said terminal distributing member.

2. The electrical connector assembly according to claim 1, wherein each of said first retention holes has a first insert hole section extending parallel to a main axis and a first distributing hole section extending parallel to a first axis; each of said second retention holes having a second insert hole section extending parallel to said main axis and a second distributing hole section extending parallel to a second axis; wherein, once said terminal holding member is coupled to said terminal distributing member, said first terminals extend respectively through said first and second insert hole sections and said first and second distributing hole sections in said terminal distributing member, thereby forming and exposing a first row of said distributing sections of said first terminals from one side of a flat end of said terminal distributing member and a second row of said distributing sections of said first terminals from the other side of said flat end of said terminal distributing member.
